(19) United States
(12) Patent Application Publication
(10) Pub. No.: US 2008/0224424 A1
(43) Pub. Date: Sep. 18, 2008

(54) Tool chucking apparatus

(75) Inventor: Peter Chen, Jhongli City (TW)

Correspondence Address: Joe McKinney Muncy, PO Box 1364, Fairfax, VA, 22038-1364, US

(73) Assignee: Primetool MFG, Inc.

(21) Appl. No.: 11/724,205

(22) Filed: Mar. 15, 2007

(51) Int. Cl. B23B 5/22

(52) U.S. Cl. 279/47

(57) ABSTRACT

A tool chucking apparatus to hold a machining cutter or tool includes a holding member and a fastening member that are coupled together to form a housing space inside to hold a clipping member in a tight manner. The coupled holding member, fastening member and clipping member form a threaded passage to hold the cutter or tool through the clipping member. The clipping member has a plurality of pawl structures which are spaced in an annular manner and formed in a conical structure. The conical structure has a top end directing towards the fastening member. The fastening member and the holding member have respectively a corresponding coupling structure. The fastening member further has an encasing portion extended towards the holding member.

### FIELD OF THE INVENTION

The present invention relates to a tool chucking apparatus and particularly to a chucking apparatus to firmly hold a tool.

### BACKGROUND OF THE INVENTION

These days precision metal machining such as drilling, tapping, boring, milling, cutting of inner or outer diameters or surface grinding usually relies on CNC (Computer Numerical Control) machine tools in cooperation with a plurality of cutters or tools. Those cutters or tools mostly have an elongated stem connecting to a driving spindle of the CNC machine tools through a chucking apparatus or chucking structure. The driving spindle rotates in high speed to drive the cutters or tools held by the chucking apparatus to perform machining on a targeted object.

Hence the holding condition of the chucking apparatus on the cutters or tools directly affects the machining precision of the targeted object. If clamping is not tight enough during high speed rotation of the machining tool idle rotation of the cutters or tools occurs. Referring to FIG. 1, a conventional chucking apparatus mainly includes a fastening member 1, a clipping member 2 and a holding member 3. The holding member 3 is connected to a driving spindle (not shown in the drawing) of a machining tool, and has a housing space 4 to hold the clipping member 2 to form a tight coupling. The clipping member 2 is a hollow conical element and has a plurality of conical pawl structures 5 formed in an annular manner with a center passage 6. The pawl structures 5 are elastic. When a cutter or tool is inserted into the clipping member 2 the inner diameter of the center passage 6 can be adjusted accordingly. The fastening member 1 and the holding member 3 have respectively a corresponding screw thread 7 and 7′ for screwing together to firmly hold the clipping member 2. In addition, as the clipping member 2 has the pawl structures 5, when the holding member 3 and the fastening member 1 are screwed together, the pawl structures 5 are forced and shrunk inwards to strengthen coupling of the cutter or tool to increase the firmness of machining and enhance the machining precision of the targeted object.

The clipping member 2 equipped with the pawl structures 5 to hold the cutter or tool has many advantages, such as can hold cutters or tools of varying sizes and specifications. Moreover, when the holding member 3 and the fastening member 1 are screwed together, they automatically clamp the cutter or tool in an optimal condition. However, when the conical top of the clipping member 2 is moved towards the holding member 3 it mainly holds the distal end of the cutter or tool. As the targeted object to receive machining usually is a hard article such as metal, and the driving spindle (not shown in the drawing) of the machining tool rotates at the high speed, with the clipping member 2 holding the distal end of the cutter or tool, only the distal end receives the force, and the cutter or tool has an excessive portion exposed outside the clipping member 2. When a great force is applied or the forcing angle is not vertical the cutter or tool could be skewed. As a result machining precision suffers. It could even cause damage of the clipping member 2 or the machining tool and result in a great loss of cost.

### SUMMARY OF THE INVENTION

The primary object of the present invention is to provide a tool chucking apparatus to enhance holding firmness of a cutter or tool on a machining tool during machining for a targeted metal to prevent suffering of precision and damage of the machining cutter or tool. To achieve the foregoing object the tool chucking apparatus of the invention includes a holding member and a fastening member. The holding member has one end coupled with the fastening member to form a housing space to hold a clipping member inside. The holding member, fastening member and clipping member are coupled together to form a holding passage to receive a machining cutter or tool, and anchor the cutter or tool through the clipping member. The clipping member has a plurality of pawl structures which are spaced in an annular manner and formed in a conical structure. The pawl structures are elastic and can adjust the inner diameter according to the cutter or tool. When they are engaged with the holding member and the fastening member they form a tight coupling with the cutter or tool to prevent the cutter or tool from loosening during machining process. Moreover, the conical structure has a top end directing towards the fastening member to allow the cutter or tool to be inserted deeply into the chucking apparatus without exposing too much outside the chucking apparatus. As a result the firmness of the cutter or tool increases and machining precision on the targeted metal improves. In addition, the fastening member and the holding member have respectively a coupling structure corresponding to each other. The fastening member further has an encasing portion extended towards the holding member to increase the holding steadiness of the bottom end of the conical structure held in the holding member so that the distal end of the cutter or tool also is held firmer. Such a structure also can prevent the tool chucking apparatus from loosening at high speed rotation or vibration during operation of the machining tool.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of a conventional tool chucking apparatus.

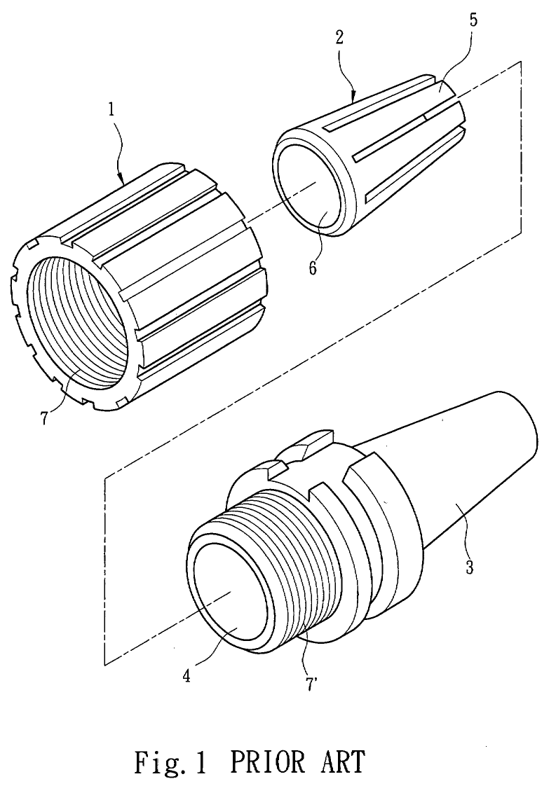

FIG. 2 is a perspective view of the tool chucking apparatus of the invention.

FIG. 3 is an exploded view of the tool chucking apparatus of the invention.

FIG. 4 is a sectional view of the tool chucking apparatus of the invention.

### DETAILED DESCRIPTION OF THE PREFERRED EMBODIMENT

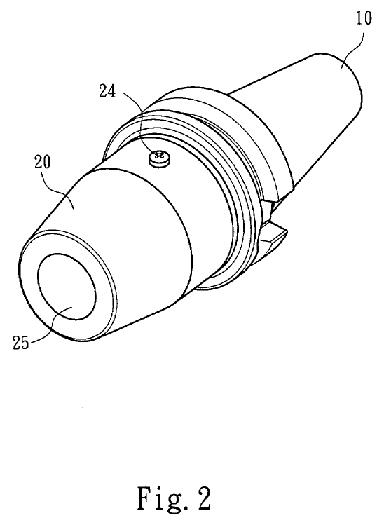

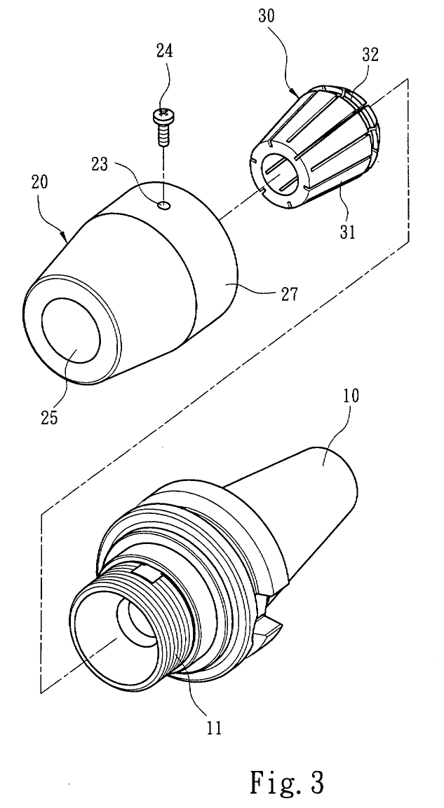

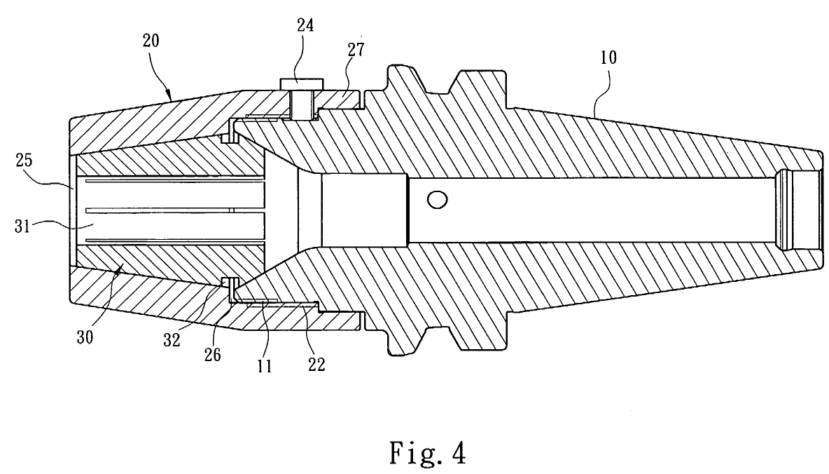

Please refer to FIGS. 2, 3 and 4, the tool chucking apparatus according to the invention aims to couple a machining tool (not shown in the drawings) with a machining cutter or tool (also not shown in the drawings), and to be connected to a driving spindle (not shown in the drawings) of the machining tool so that the machining tool can drive the cutter or tool held by the tool chucking apparatus to rotate at high speed to do machining on a targeted object (not shown in the drawings). The tool chucking apparatus of the invention includes a holding member 10 and a fastening member 20 coupling with the holding member 10 to form a housing space inside to hold a clipping member 30 in a tight manner. The holding member 10 has one end connecting to the driving spindle and another end forming a first screw thread 11. The fastening member 20 has a second screw thread 22 corresponding to the first screw thread 11 that can engage with each other to form a tight fastening between the fastening member 20 and the holding member 10 (in an embodiment of the invention coupling of the fastening member 20 and the holding member 10 is accomplished through the screw threads, but it is not the main feature of the invention). To prevent the holding member 10 and fastening member 20 from loosening during the high speed rotation at least one through threaded passage 23 may be formed at the coupling juncture to receive at least one corresponding bolt 24. Hence after the holding member 10, fastening member 20 and clipping member 30 are coupled together, a passage 25 is formed in the center to receive a machining cutter or tool.

The clipping member 30 is the main holding structure of the cutter or tool. It has a plurality of pawl structures 31 which are spaced from one another in an annular manner and formed in a conical structure to generate a desired elasticity. When the cutter or tool of varying specifications is inserted, the pawl structures 31 can adjust the inner diameter. After the clipping member 30 has been held in the holding member 10 and the fastening member 20 is coupled with the holding member 10, the pawl structures 31 is shrunk naturally inwards to tightly clamp the cutter or tool to prevent it from loosening during machining at high rotation speed. Moreover, differs from the conventional structure that has the top end of the conical structure of the clipping member 30 directing towards the holding member 10 or driving spindle, the top end of the conical structure of the clipping member 30 of the invention is directed towards the fastening member 20. Thereby the machining cutter or tool is held deeply in the tool chucking apparatus without exposing too much outside. Such a design increases the contact area of the cutter or tool and the tool chucking apparatus, and reduces the impact of external forces. Thus machining precision of the cutter or tool on the targeted object improves significantly.

As previously discussed, the holding member 10 and the fastening member 20 are coupled through the corresponding screw threads 11 and 22. As the top end of the conical structure of the clipping member 30 is directed towards the fastening member 20, the bottom end of the conical structure is in contact only with the holding member 10. During high speed rotation no adequate support is provided. To remedy this problem the conical structure has an annular groove 32 at the bottom end. The fastening member 20 has a corresponding annular fastening portion 26 on an inner side of the distal end to be wedged in the groove 32 to form a tight coupling. Thereby the bottom end of the clipping member 30 has sufficient support. Moreover, the fastening member 20 has an encasing portion 27 extended towards the holding member 10 to enhance the coupling steadiness of the holding member 10 with the bottom end of the clipping member 30.

By means of the construction set forth above, the cutter or tool used in machining can be deeply held in the tool chucking apparatus and get a greater contact area. Hence the cutter or tool can be held firmer, and the exposed portion is smaller and less likely affected by external forces. As a result the firmness and precision of the cutter or tool at the high speed rotation increase significantly. To strengthen the distal structure of the clipping member 30 the annular groove 32 is formed thereon to be wedged by the corresponding annular fastening portion 26 of the fastening member 20, and the encasing portion 27 is extended from one end of the fastening member 20 to increase coupling strength of the distal end of the clipping member 30 held in the holding member 10. These features provide firmer support for the distal end of the inserting cutter or tool.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A tool chucking apparatus for holding a machining cutter or tool, comprising:
a holding member;
a fastening member coupling with the holding member; the holding member having one end coupled with the fastening member to form a housing space, the holding member and the fastening member having respectively a coupling structure corresponding to each other, the fastening member having an encasing portion extended towards the holding member; and
a clipping member held tightly in the housing space to form a hollow installation passage in the center of the coupled holding member, fastening member and clipping member to receive and anchor the cutter or tool, the clipping member having a plurality of pawl structures which are spaced in an annular manner and formed a conical structure which has a top end directing towards the fastening member.

2. The tool chucking apparatus of claim 1, wherein the fastening member has an annular fastening portion, the clipping member having an annular groove to be wedged in by the fastening portion to form a tight coupling.

3. The tool chucking apparatus of claim 1, wherein the coupling structure of the fastening member and the holding member is a corresponding screw thread structure to screw the fastening member and the holding member together.

4. The tool chucking apparatus of claim 1, wherein the fastening member and the holding member form a coupling juncture which has at least one through threaded passage to receive at least one corresponding bolt.
